(19) United States
(12) Patent Application Publication
(10) Pub. No.: US 2026/0155406 A1
(43) Pub. Date: Jun. 4, 2026

(54) BIPOLAR PLATE AND METHOD FOR PRODUCING A BIPOLAR PLATE

(71) Applicant: Schaeffler Technologies AG & Co. KG, Herzogenaurach (DE)

(72) Inventors: Hanna Winter, Karlsruhe (DE); Sebastian Zwahr, Obermichelbach (DE); Nico Alexander Mattes, Karlsruhe (DE)

(73) Assignee: Schaeffler Technologies AG & Co. KG, Herzogenaurach (DE)

(21) Appl. No.: 18/872,351

(22) PCT Filed: May 2, 2023
(86) PCT No.: PCT/DE2023/100314

§ 371 Date: Dec. 6, 2024

(30) Foreign Application Priority Data
Jun. 29, 2022 (DE) 10 2022 116 193.5

(51) Int. Cl. H01M 8/04029; H01M 4/86

(52) U.S. Cl. CPC H01M 8/04029; H01M 2004/8694

(57) ABSTRACT

A bipolar plate is disclosed for use in a stack of electrochemical cells and is constructed from two half-plates that are situated one above the other has three ports which are arranged next to one another. An active field and a distributor field which connects the ports to the active field and is designed to conduct three different fluids between the ports and the active field, wherein a flow space for one of the fluids is formed between the half-plates and flow spaces for the two other fluids are formed on the outer sides of the half-plates. The distributor field comprises four flow fields of flat design, in particular each having a triangular basic shape.

### CROSS-REFERENCE TO RELATED APPLICATIONS

This application is the U.S. National Phase of PCT Appln. No. PCT/DE2023/100314 filed May 2, 2023, which claims priority to DE 10 2022 116 193.5 filed Jun. 29, 2022, the entire disclosures of which are incorporated by reference herein.

### TECHNICAL FIELD

The disclosure relates to a bipolar plate intended for use in a stack of electrochemical cells. The disclosure further relates to a method for producing such a bipolar plate.

### BACKGROUND

A generic bipolar plate and a fuel cell unit constructed therewith is known, for example, from DE 10 2005 057 045 A1. The known bipolar plate is constructed from a cathode-side and an anode-side partial plate, i.e., from two half-plates. An interior space which can be flowed through is formed between the half-plates. Other fluids, namely operating media of the fuel cell unit, flow around the outer sides of the bipolar plate. In a distributor region of the bipolar plate, the two half-plates are supported against each other by raised, negative support points.

As with the bipolar plate according to DE 10 2005 057 045 A1, in numerous other possible designs of bipolar plates, three ports, namely one port for coolant and two ports for operating media, are arranged next to each other. In this context, reference is made by way of example to documents U.S. Pat. No. 10,381,675 B2 and DE 10 2014 206 333 A1. In both cases, there are overlaps between different channels formed between inlets or outlets, i.e., ports, and an active field of a fuel cell. Other possible designs of bipolar plates which include flow channels are described, for example, in documents DE 10 2013 210 542 A1, U.S. Pat. Nos. 9,685,664 B4 and 9,337,498 B2.

The designs of bipolar plates and entire fuel cells disclosed in documents EP 3 577 708 B1 and EP 3 167 505 B1 are intended to achieve improved flow distributions and reactant flows. Both documents deal with fuel cells with gas diffusion layers and catalytic substances. A further fuel cell with flow distributors is described, for example, in EP 2 926 399 B1.

### SUMMARY

The disclosure is based on the object of further developing bipolar plates suitable for use in fuel cell stacks compared with the aforementioned prior art with regard to flow-related and production-related aspects.

This object is achieved according to the disclosure by a bipolar plate having the features described herein. The bipolar plate can be produced in a method according to the disclosure.

The bipolar plate, which is suitable for use in a stack of electrochemical cells, in particular fuel cells, is constructed in a known basic concept from two superimposed, interconnected half-plates. The bipolar plate has three ports arranged next to each other for supplying or discharging fluids. For example, a first such arrangement of three ports is provided for supplying fluids and a second such arrangement of three ports is provided for discharging fluids. It is also possible for fluids to flow in counterflow, so that out of three ports arranged next to each other, a single port is provided for guiding a fluid which flows through or around the bipolar plate in the opposite direction to the fluids which are passed through the other two ports in the same row of ports. The ports are also referred to as manifold openings or simply as manifolds.

A generally central, extended section of the bipolar plate is assigned to the active field of the respective electrochemical cell, i.e., the region in which the desired electrochemical reactions take place, wherein the term “active field” is also used for the corresponding section of the bipolar plate. In many designs, the active field of the bipolar plate has a rectangular basic shape. Furthermore, there is a distributor field of the bipolar plate, which connects the ports with the active field, i.e., which is designed to conduct the three different fluids between the ports and the active field. A flow space for one of the three fluids is formed between the half-plates. This is generally a flow space for coolant, in particular cooling water. Flow spaces are simultaneously formed on the outer sides of the half-plates for the other two fluids, i.e., typically for the operating media of the electrochemical cells.

According to the disclosure, the distributor field comprises four flat flow fields in plan view of the half-plates, each having a triangular basic shape:
one coolant flow field which is open to the central port of the three ports,
two two-media flow fields which each at one end adjoin the coolant flow field and at the other end are open to one of the two outer ports and which are each designed for coolant to flow through and with an operating medium as a further fluid in layers that are parallel to each other,
one three-media flow field which adjoins the two two-media flow fields, is open to the active field and is designed for coolant to flow through and with the operating media as further fluids in three superimposed layers that are parallel to each other.

Here, the half-plates are structured by embossed, in particular circular, structures, which are designed as points, that is to say in the form of islands, in each of the four flow fields in such a way that the half-plates are supported both against each other and against flat components arranged outside the half-plates. Besides a triangular basic shape of the flow fields, flow fields with other shapes, for example square or pentagonal, may also be possible. This applies in particular to the coolant flow field as well as to the two lateral flow fields, i.e., the two-media flow fields. All four flow fields act as pressure loss-controlled flow fields during operation of the electrochemical cell stack in typical methods. With regard to the use of parallel layers, in each of which a medium flows, this is to be understood to mean that the layers are arranged essentially parallel to each other, i.e., they lie one above the other, wherein flow components perpendicular to the planes given by the individual layers can also appear.

In plan view of the bipolar plate, there can be a single point at which all four flow fields meet. This is in particular true for designs with triangular flow fields. The first flow field connected to the central port, as well as the fourth flow field, through which all three media flow and which is arranged closest to the active field, can describe an isosceles triangle. The two two-media flow fields, which typically do not describe isosceles triangles, can be of similar design.

In each of the four flow fields that are part of the distributor field, the fluid in this flow field spreads out, or the two or three different fluids that flow in separate, superimposed layers spread out over a surface. The stacking of the layers is always consistent. This means, for example, that the medium, i.e., fluid, which is in the uppermost layer is only conducted in this layer. The lack of diversion of a medium from one layer to another layer, for example from the top side of the bipolar plate to its bottom side, is particularly advantageous with regard to the flow resistance occurring during operation of the cell stack, in particular the fuel cell stack.

According to one possible embodiment, the half-plates in the region of the coolant flow field are provided for bearing flat against a surrounding, similarly flat component of the cell stack. In comparison to the region adjacent to said component, there is a relatively small proportion of the region of the coolant flow field in which round, in particular circular, supports are formed which keep the half-plates at a distance from each other. The height of these supports corresponds to half the maximum distance between the two half-plates, provided that the embossing depth of both half-plates is identical. Within the flow space through which the coolant flows, the supports represent pin-shaped barriers which, on the one hand, do not significantly narrow the free flow cross-section and, on the other hand, ensure an even distribution of the coolant. This also applies to variants in which coolant is supplied or drained through a plurality of ports.

As far as the two-media flow fields are concerned, the half-plates in the region of these flow fields are provided according to one possible embodiment on exactly one outer side for bearing flat against a surrounding, similarly flat component, whereas the half-plate forming the opposite outer side is provided for arrangement largely spaced apart from a similarly flat surrounding component. Thus, there are three planes that can be distinguished from each other, namely a center plane in which both half-plates are tangent to each other, a plane in which one of the two half-plates is in flat contact with a surrounding component, and a further plane described by the other half-plate, which is elevated in a defined manner from a flat surrounding component in order to provide a free, flat flow cross-section for an operating medium. The distance between the latter plane is at most half the maximum distance between the two half-plates. At the same time, the same half-plate defining said flow cross-section forms supports which project beyond said plane parallel to the center plane and are intended to support the bipolar plate with respect to the flat component which is largely elevated from said half-plate.

The middle plane is generally referred to as the plane in which the two half-plates bear flat against each other. This also applies to designs in which the different half-plates have different drawing depths. In such cases, the two half-plates protrude from the center plane to different distances.

In the three-media flow field, each of the two half-plates can have a profile which, with regard to the existence of regions elevated flat from the center plane and outwardly facing supports, basically corresponds to the described profile of the half-plate of the two-media flow field, which is largely elevated flat from the surrounding component, wherein in the three-media flow field, the distances of regions of the half-plates elevated flat from the center plane and from a surrounding component in each case are smaller than the distance in the two-media flow field between the center plane and a plane defined by one of the half-plates and spaced parallel from a surrounding component. Even in the three-media flow field, in a typical design the sum of the areas of all the supports-in plan view of the bipolar plate-is less than half of the total area of the corresponding flow field.

In the two-media flow fields and in the three-media flow field, there are different possibilities for designing and arranging the supports: For example, the layout of the bipolar plate can be designed in such a way that the inwardly and outwardly facing supports of the half-plates are offset from each other. Alternatively, a concentric arrangement of the inwardly and outwardly facing supports of the half-plates is possible.

According to a possible further development, a channel-guided region of the distributor field is connected between the three-media flow field and the active field of the bipolar plate and thus the entire electrochemical cell, wherein the width of said distributor field can correspond to the width of the active field and the width of the three-media flow field. In this design, the various media flows on the cathode side and the anode side, as well as the coolant flow, can be distributed to a good approximation in an even manner over the entire width of the active field. In particular, the channel-guided region can be designed using channels of uneven width in such a way that a uniform flow distribution is achieved across the entire width.

The metallic bipolar plate according to the disclosure can generally be produced by three-dimensionally structuring two half-plates, in particular made of sheet steel, alternatively for example of a titanium alloy, by means of forming processes according to the disclosure and then joining them together. The connection can be made, for example, by soldering, welding or gluing. Continuous and/or discontinuous processes can be used to profile the half-plates.

### BRIEF DESCRIPTION OF THE DRAWINGS

Two exemplary embodiments of the disclosure are explained in more detail below with reference to a drawing. The figures show the following in an, in parts, roughly simplified manner:

FIG. 1 shows sections of a bipolar plate for a stack of electrochemical cells in a symbolic plan view,

FIG. 2 shows structures of a coolant flow field in a distributor field region of the bipolar plate according to FIG. 1,

FIG. 3 shows structures of a two-media flow field and a three-media flow field of the bipolar plate according to FIG. 1,

FIG. 4 shows a section through a flow field attributable to a distributor field, namely a coolant flow field, of the bipolar plate according to FIG. 1,

FIG. 5 shows a section through one of two similarly designed two-media flow fields of the bipolar plate according to FIG. 1,

FIG. 6 shows a section through the three-media flow field of the bipolar plate according to FIG. 1,

FIG. 7 shows sections of a further embodiment of a bipolar plate for a stack of electrochemical cells in a simplified plan view,

FIG. 8 shows a section from the arrangement according to FIG. 7,

FIG. 9 shows a section through the coolant flow field of the bipolar plate according to FIG. 7,

FIG. 10 shows a section through a two-media flow field of the bipolar plate according to FIG. 7, intended for conducting a coolant and one of two operating media,

FIG. 11 shows a section through the three-media flow field of the bipolar plate according to FIG. 7.

### DETAILED DESCRIPTION

Unless otherwise stated, the following explanations relate to both exemplary embodiments. Parts which correspond to each other or which have basically the same effect are identified with the same reference sign in all the figures.

A bipolar plate marked with reference symbol 1 is a part of a PEM fuel cell stack that is not shown further. With regard to the basic structure and function of such a fuel cell system, reference is made to the prior art cited at the outset. The bipolar plate 1 can be intended for stationary or mobile use, in particular in a motor vehicle. If terms such as “top side” or “bottom side” are used below, this does not imply any statement about the actual installation position of the bipolar plate 1 in an adjacent construction. In particular, the bipolar plates 1 can be aligned vertically, unlike as shown in the figures.

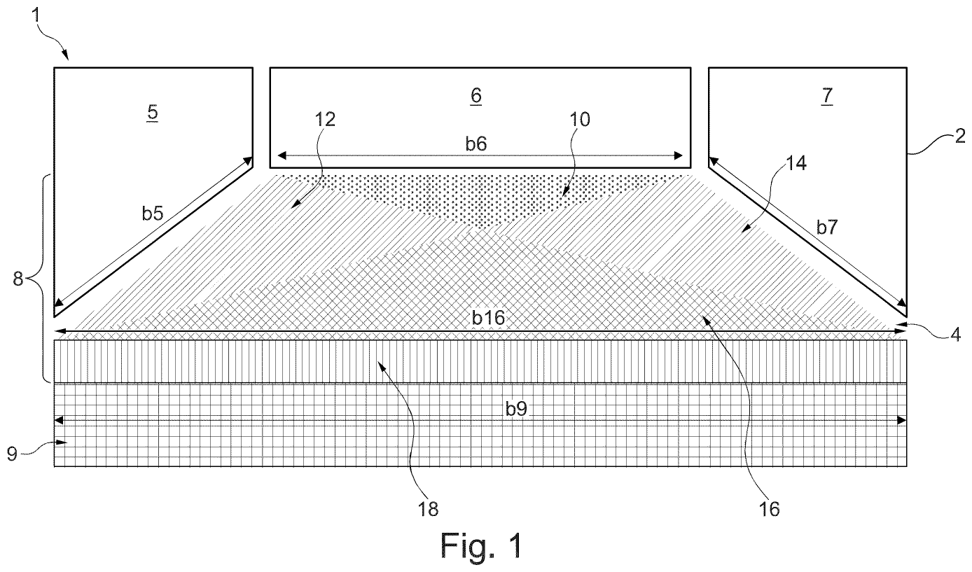

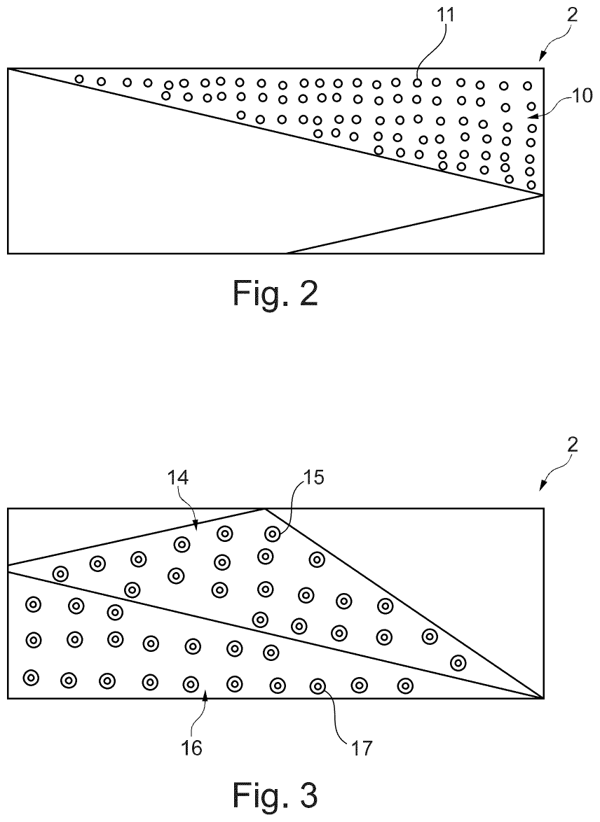

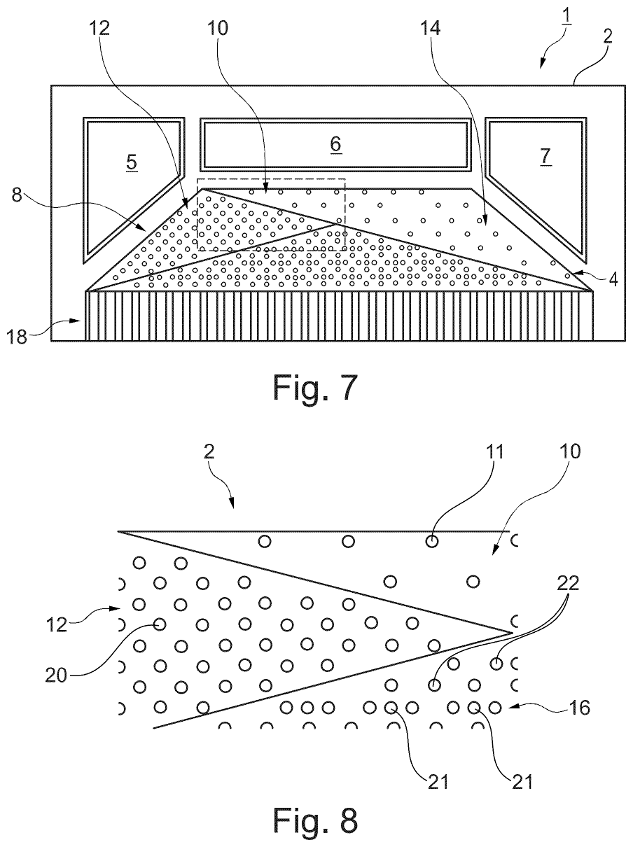

The bipolar plate 1 is composed of two profiled half-plates 2, 3. Embossed structures of the half-plates 2, 3 are generally designated 4. In the present cases, the bipolar plate 1 has an overall rectangular, not square, basic shape, wherein one of the narrow sides and only sections of the long sides are visible in FIGS. 1 and 7. Other designs of bipolar plates 1, for example square or bone-shaped, are also possible.

There is a plurality of ports 5, 6, 7 on the narrow sides of the sketched bipolar plates 1. These are a port 5 for the cathode cavity of the fuel cell, a port 6 for coolant, and a port 7 for the anode cavity. The ports 5, 6, 7 are arranged next to each other in a row, wherein the port 6 for the coolant is located between the ports 5, 7 for the operating media. In the embodiments, the ports 5, 7 are square, namely shaped as trapezoids, while the port 6 in plan view describes an elongated rectangular shape extending along the narrow side of the half-plates 2, 3.

The arrangement of the three ports 5, 6, 7 adjoins a distributor field marked as a whole with 8, which is fluidically connected between the ports 5, 6, 7 and an active field 9 of the bipolar plate 1. The width of the individual ports 5, 6, 7, each measured at the transition to the distributor field 8, is marked as b5, b6, b7. The distributor field 8 includes a channel-guided region marked 18, which borders on the active field 9. Furthermore, the distributor field 8, as will be explained in more detail below, is designed without any channel guiding.

Adjacent to the port 6 is a coolant flow field 10, which represents one of four distinguishable flow fields 10, 12, 14, 16 from which the distributor field 8 is constructed, apart from the channel-guided region 18. Each of the flow fields 10, 12, 14, 16 has a triangular basic shape.

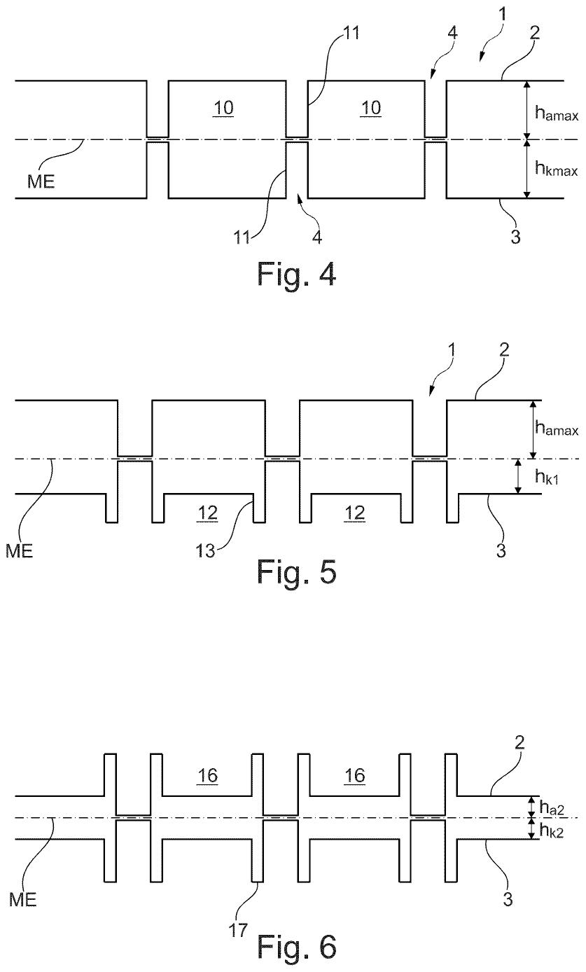

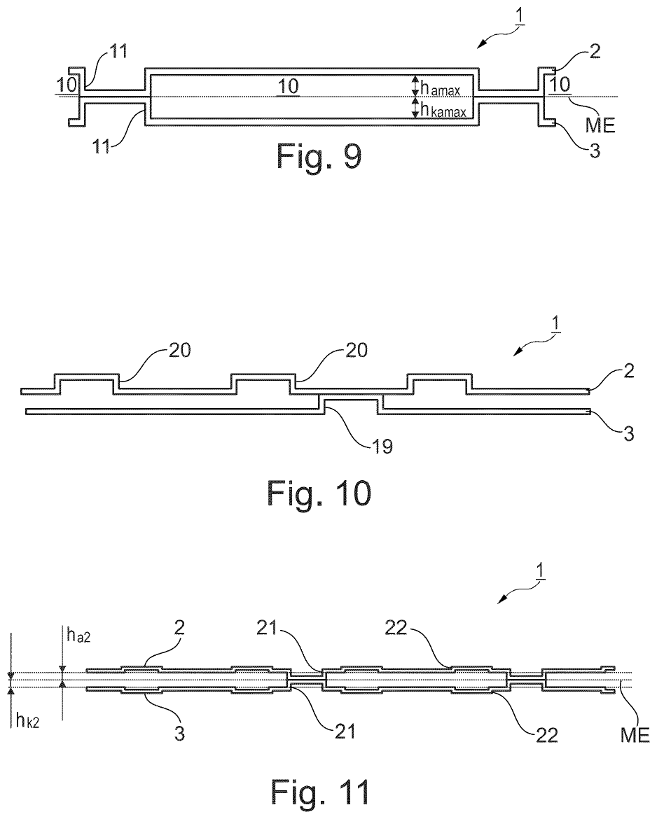

Possible cross-sectional designs of the coolant flow field 10 are shown in FIGS. 4 and 9. The two half-plates 2, 3 are largely elevated from the center plane ME, in which the half-plates 2, 3 come into contact with each other, so that the largest possible flow cross-section is provided for the coolant. The distance of the planes in which the half-plates 2, 3 are mostly located from the center plane ME is hₐₘₐₓ (anode side) or hₖₘₐₓ (cathode side). Further similarly flat components of the fuel cell stack (not shown) bear against the continuously flat regions of the half-plates 2, 3, which are spaced by an amount hₐₘₐₓ or hₖₘₐₓ from the center plane ME. Pin-shaped supports 11, which are circular in plan view, are formed directly through the half-plates 2, 3 and keep the half-plates 2, 3 at a distance from each other.

In addition to the coolant, one of two operating media of the fuel cells flows in the flow field 12. The flow field 12 thus represents a two-media flow field. The same applies to the flow field 14. Compared to the coolant flow field 10, there is significantly less free flow cross-section for the coolant in the two-media flow fields 12, 14. In the cases outlined in the figures, the two two-media flow fields 12, 14 are identically constructed and arranged point-symmetrically to each other. In contrast, for example, the anode port can be smaller than the cathode port, so that there is no symmetry.

One of the two half-plates 2, 3 is structured in the two-media flow field 12, 14 in the same way as in the coolant flow field 10. In the case of FIG. 5, this applies to the upper half-plate 2; in the case of FIG. 10 to the lower half-plate 3. The aforementioned point symmetry, which is not necessarily present and can be seen in FIGS. 1 and 7, refers to a point at which all the flow fields 10, 12, 14, 16 meet.

The second half-plate 3, 2 lies in the two-media flow field 12, 14 mostly in a plane which is offset by an amount hₖ₁, hₐ₁ from the center plane ME, where hₖ₁ or hₐ₁ is less than hₖₘₐₓ or hₐₘₐₓ. In the design according to FIG. 5, the half-plate 3, which in this case is largely offset by the amount hₖ₁ from the center plane ME, supports 13 are formed which support the half-plate 3 both inwardly, i.e., towards the other half-plate 2, and outwardly, i.e., towards a flat surrounding component. The cathode gas is passed through the flow field 12. The supports 13 appear ring-shaped in plan view. The same applies to the supports 15 which are located in the flow field 14 through which the anode gas is passed.

In contrast to the design according to FIG. 1, in the design according to FIG. 7, in the two-media flow fields 12, 14 provided for conducting the cathode or anode gas, as well as in a three-media flow field 16, there are different partial supports 19, 20, 21, 22, which support the half-plates 2, 3 in different directions and are arranged next to each other in the plan view.

The three-media flow field 16, which, like the flow fields 10, 12, 14, is designed as an open flow field, also in the design according to FIG. 1, adjoins both the two two-media flow fields 12, 14 and the channel-guided region 18 of the distributor field 8. In the exemplary embodiments, the width of the three-media flow field 16 indicated as b16 corresponds to the width b9 of the active field 9 and also to the width of the region 18. In the case of FIG. 1, numerous supports 17 are formed in the three-media flow field 16, which, like the supports 13, 15, are ring-shaped in plan view.

In the three-media flow field 16, a flow of the operating media and the cooling medium is projected in three layers one above the other, wherein the coolant flow represents the central layer. The flow cross-section available to the coolant is limited at the top and bottom by planes which are defined by the half-plates 2, 3 and are reduced by the amount hₐ₂ or hₖ₂ from the center plane ME. Here hₐ₂ is less than hₐ₁ and hₖ₂ is less than hₖ₁. In the exemplary embodiments, hₐ₁ is identical to hₖ₁ and hₐ₂ is identical to hₖ₂.

### LIST OF REFERENCE SYMBOLS

1 Bipolar plate
2 Half-plate
3 Half-plate
4 Embossed structure
5 Cathode cavity port
6 Coolant port
7 Anode cavity port
8 Distributor field
9 Active field
10 Coolant flow field
11 Support in the coolant flow field
12 Coolant and cathode-side flow field
13 Support in the flow field 12
14 Coolant and anode-side flow field
15 Support in the flow field 14
16 Flow field for three fluids
17 Support in the flow field 16
18 Channel-guided region of the distributor field
19 Partial support in the flow field 12
20 Partial support in the flow field 12
21 Partial support in the flow field 16
22 Partial support in the flow field 16
b5 Width of the port 5
b6 Width of the port 6
b7 Width of the port 7
b9 Width of the active field
b16 Width of the flow field 16
hₐₘₐₓ Maximum embossing depth, anode side
ha1, ha2 Embossing depth, anode side
hk1, hk2 Embossing depth, cathode side
hₖₘₐₓ Maximum embossing depth, cathode side
ME Center plane

1. A bipolar plate for electrochemical cells, constructed from two half-plates situated one above the other, comprising: three ports arranged next to each other, an active field and a distributor field which connects the ports to the active field and is designed to conduct three different fluids between the ports and the active field, wherein a flow space for one of the fluids is formed between the half-plates and flow spaces for the other two fluids are formed on outer sides of the half-plates, wherein the distributor field comprises four flow fields of flat design, comprising:
one coolant flow field which is open to a central port,
two two-media flow fields which each at one end adjoin the coolant flow field and at the other end are open to one of two outer ports and which are each designed for coolant to flow through and with an operating medium as a further fluid in layers that are parallel to each other,
one three-media flow field which adjoins the two two-media flow fields, is open to the active field and is designed for coolant to flow through and with an operating media as further fluids in three layers that are parallel to each other,
wherein the half-plates are structured by embossed structures, which are designed as points, that is to say in the form of islands, in each of the four flow fields in such a way that the half-plates are supported both against each other and against flat components arranged outside the half-plates.

2. The bipolar plate according to claim 1, wherein the four flow fields of the distributor field each have a triangular basic shape in plan view of the half-plates wherein all four flow fields meet at a single point.

3. The bipolar plate according to claim 1, wherein the two two-media flow fields are of similar design.

4. The bipolar plate according to claim 1, wherein the half-plates are provided in a region of the coolant flow field for bearing flat against a surrounding, similarly flat component, wherein in a comparatively small proportion of the region of the coolant flow field round, supports are formed which keep the half-plates at a distance from each other, a height of which corresponds to half the maximum distance between the half-plates.

5. The bipolar plate according to claim 1, wherein the half-plates in a region of the two-media flow fields are provided on exactly one outer side for bearing flat against a surrounding, similarly flat component, whereas the half-plate forming the respective opposite outer side is provided for arrangement largely spaced apart from a similarly flat surrounding component, wherein, measured from a center plane (ME) in which both half-plates are tangent to each other, ai majority of the half-plate which is largely elevated from the surrounding component lies in a plane which is offset from the center plane (ME) by an amount (hk1, ha1) which is at most as large as half the maximum distance between the two half-plates, and wherein the same half-plate simultaneously forms supports which project beyond said plane parallel to the center plane (ME) and are provided for support against the flat component which is largely elevated from said half-plate.

6. The bipolar plate according to claim 5, wherein in the three-media flow field, each of the two half-plates has a profile which, with regard to the existence of regions elevated flat from the center plane (ME) and outwardly facing supports corresponds to the profile of the half-plate of the two-media flow field which is largely elevated flat from the surrounding component, wherein in the three-media flow field, the distances (hk2, ha2) of regions of the half-plates elevated flat from the center plane (ME) and from a surrounding component in each case are smaller than the distance (hk1, ha1) in the two-media flow field between the center plane (ME) and a plane defined by one of the half-plates and spaced parallel from a surrounding component.

7. The bipolar plate according to claim 5, wherein the inwardly and outwardly facing supports of the half-plates are arranged offset from each other.

8. The bipolar plate according to claim 5, wherein the inwardly and outwardly facing supports of the half-plates are arranged concentrically to each other.

9. The bipolar plate according to claim 1, wherein a channel-guided region of the distributor field is connected between the three-media flow field and the active field wherein the width of said channel-guided region corresponds to the width of the active field and the width of the three-media flow field.

10. A method for producing a bipolar plate for electrochemical cells, wherein two half-plates are three-dimensionally structured by means of forming methods according to claim 1 and then permanently connected to each other.
